(19) United States
(12) Patent Application Publication
(10) Pub. No.: US 2006/0161877 A1
(43) Pub. Date: Jul. 20, 2006

(54) Device and method for data-processing

(76) Inventors: Mana Hamada, Fukuoka (JP); Masayoshi Tojima, Fukuoka (JP); Koji Kai, Fukuoka (JP); Tsuyoshi Nakamura, Kasuya-Gun (JP); Akihiko Inoue, Kasuya-Gun (JP)

Correspondence Address: WENDEROTH, LIND & PONACK L.L.P., 2033 K. STREET, NW, SUITE 800, WASHINGTON, DC, 20006, US

(21) Appl. No.: 11/289,442

(22) Filed: Nov. 30, 2005

(30) Foreign Application Priority Data
Dec. 1, 2004 (JP) 2004-348084

(51) Int. Cl. G06F 17/50

(52) U.S. Cl. 716/18

(57) ABSTRACT

A total specification is divided into a hardware specification and a software specification. With respect to the hardware specification, a first hardware description is described. With respect to the software specification, an object program is generated, which is converted into a second hardware description. The first and second hardware descriptions are logically synthesized into a net list, which includes a part that fulfills the software specification. Since the object program is converted into the second hardware description, which is logically synthesized, the redundancy of the program can be removed and cost for manufacturing hardware can be reduced.

### BACKGROUND OF THE INVENTION

1. Field of the Invention

The present invention relates to a data-processing device used for an electric device (e. g., an electrical appliance, an AV (audio/visual) apparatus, a cellular phone, a car, and so on.), and particularly to a data-processing device according to a program control system.

2. Description of the Related Art

The data-processing device (e. g., a microprocessor, a micro-controller, and so on.) is built into the electric device, performs various kinds of applications, and controls operation of the electric device.

FIG. 10 of document 1 (Japanese Patent Application Laid-Open No. 16642) discloses design procedures of the data-processing device according to a general program control system. As shown in document 1, the combination of hardware and software constructs total specifications necessary for the data processing system according to the program control system.

The hardware is composed of a data path, a storage, a transmission path, a control unit, and so on. The software is a program for controlling the hardware.

Since a designing method for the hardware greatly differs from that of the software, the total specifications are usually divided into hardware specifications and software specifications at the first stage of the design, and then detailed design based on the hardware specifications and the detailed design based on the software specifications are performed in accordance with the respective designing method.

In the design based on the hardware specifications, detailed design items, such as control mechanism, the number of registers, and storage construction, are determined. A command set design is performed as a design of an important one of the detailed design items. The command set is a set of various commands for controlling hardware elements to perform data-processing. After a format of the command set has been determined, a hardware portion that interprets and executes a command is designed. The designed command set is inputted into a compiler in order to be used in the software design.

The hardware elements are usually expressed by a hardware description in a hardware description language.

In a next logical design process, the hardware description will be logically synthesized utilizing a synthesis tool to be converted into a net list. Afterward, timing is adjusted, and a mask pattern will be created in layout process.

On the other hand, in the design based on the software specifications, a source program is described, and then the source program is converted into an object program by the compiler using the command set in the hardware design. The compiler has been designed according to information of the command set and the hardware.

The object program is stored as an array whose elements are a great number of command codes in a memory (e. g., a ROM or a RAM) of the data-processing device manufactured by the mask pattern. The general data-processing device is composed of some computing units, a storage (memory), and a transmission path that connects them.

FIG. 7 illustrates general internal construction of the conventional data-processing device. As shown in FIG. 7, this data-processing device (microcomputer) comprises the following elements.

An input/output control circuit 401 controls input/output of data with the exterior. A storage 402 stores data, such as data of command codes, a target of computing, and a result of the computing. A data path 406 computes and transmits the data.

A control circuit 410 decodes command codes and outputs control signals to the data path 406. The input/output control circuit 401, the storage 402, the data path 406, and the control circuit 410 connect to an internal bus 411 connects, which enables transmission and reception of data therebetween.

The data path 406 comprises the following elements. A program counter 403 is a kind of register and stores a head address of a command code stored in the storage 402 to be operated next. A general-purpose register 404 stores various kinds of data. A computing unit 405 performs necessary calculation with respect to the data stored in the general-purpose register 404.

The control circuit 410 comprises the following elements. A command register 407 stores temporarily a command code read from the storage 402. A command decoder 408 decodes the command code stored in the command register 407, and outputs control signals to the data path 406. A timing-signal generating unit 409 generates synchronous clock signals concerning whole operation of the data-processing device.

Next, operation of the microcomputer of FIG. 7 will now be explained. Assume that the microcomputer carries out parallel processes under pipeline control composed of the following stages.

Stage 1: The head address of a program is read from a predetermined address of the storage 402, and is set to the program counter 403.

Stage 2: A command code stored in the address specified by the program counter 403 is read from the storage 402, and is set to the command register 407.

Here, the value of the program counter 403 is incrementally added as often as the command code is read.

Stage 3: The command decoder 408 decodes the command code stored in the command register 407, and outputs control signals to the data path 406.

Stage 4: The data path 406 executes a command according to the control signals.

When the command code is a code for a branch instruction, a command code address that the branch instruction indicates is set to the program counter 403, and the parallel processes under the pipeline control are initialized. Then, the processing processes of the stages 2-4 are performed in a pipeline manner for every command code.

In recent years, it is required that the data-processing device according to the program control system should be inexpensive and highly efficient. However, as specifications become more complicated, the size of the program for software processing, and the capacity of the storage that stores the program seriously increase.

In many cases, the proportion of the chip area of the storage to the total chip area is greater than one to two, and it is thought that the proportion will increase further from now on. Therefore, a method that reduces the capacity of the storage to suppress the increase in the chip area of the storage has been proposed as follows.

Document 2 (Japanese Patent Application Laid-Open No. 9-231071) discloses a method that compresses a command code length, thereby reducing the memory capacity. Command codes and data in a program are converted into compressed codes whose code length are less than the command codes and the data, and are stored in a compressed code memory. Data for developing the compressed codes to the command codes and the data are stored in a dictionary memory, and the compressed codes are utilized as addresses of the dictionary memory for reading data therefrom.

Document 3 (Japanese Patent Application Laid-Open No. 2001-318788) discloses technique that re-expresses repetitious processes in a program utilizing one set of compressed codes. Due to this, the consumption amount of the memory for storing the program is reduced. A compressed code, whose code length is short, is related to each of continuous command codes.

The compressed command codes are located in the storage according to a processing procedure. A code conversion register converts the compressed command codes into the original command codes thereof, and a code conversion-processing unit refers to the compressed command codes to calculate the address of a corresponding command codes in the storage according to code-converting information.

According to the document 2 (the method for compressing the command code lengths), when the original command code lengths are long (e. g., 32 bits), high compression ratio (about 60%) can be realized. That is because, in many cases, ways of commands used in an actual program are extremely fewer than the 32nd power of 2, whereas there are the 32nd powers of 2 ways that the commands can take at most.

Ways that the commands can take at most remarkably decrease from the above when the original command code lengths are short (e. g., 16 bits). Then, compression ratio becomes low, because ways of commands used in the actual program are almost as the same as the above.

Even if the original command code lengths are long (e. g., 32 bits), a ROM especially designed for halfway bit size, which is not the powers of 2 suitable for computer processing, is needed. That is because the code lengths of compressed codes become the halfway bit size in order to perform optimal compression. According to the document 3, new additional hardware (a code conversion register, code conversion unit, and so on.) should be provided.

The code conversion register and/or the code conversion unit should develop the compressed codes into the original codes. Accordingly, the number of command execution pipeline stages cannot help being affected.

Each of documents 2 and 3 needs additional hardware and memory space depending on the program and/or the command set to be stored.

Whenever the program and/or the command set to be stored change/changes, it is necessary to re-design the additional hardware, the memory space, compression command codes, and so on. Flexibility is lacking taking the man-day and a great risk therefore into consideration.

### OBJECTS AND SUMMARY OF THE INVENTION

In view of the above, an object of the present invention is to provide a designing method for reducing the cost for hardware that stores command codes depending upon neither the program nor the command set, and an art related thereto.

A first aspect of the present invention provides a method for designing a data-processing device, comprising: generating, based on a software specification, an object program including a set of a command address and a command code; converting the set of the command address and the command code into a hardware description; and generating a net list according to the hardware description.

A second aspect of the present invention provides a method as defined in the first aspect of the present invention, wherein the hardware description includes a description conditionally describing a command code to be executed in accordance with the command address.

A third aspect of the present invention provides a method for designing a data-processing device, comprising: generating, based on a hardware specification, a first hardware description and a command set; generating a source program based on a software specification and the command set; converting the source program into an object program including a set of a command address and a command code; converting the set of the command address and the command code into a second hardware description; and logically synthesizing the first and second hardware descriptions, thereby generating a net list.

With these structures, the object program in a hardware-executable format need not be stored in a memory area like the conventional art, but is converted into the hardware description. The hardware description is logically synthesized equally to the other hardware descriptions described fulfilling the hardware specification.

It is unnecessary to provide an additional specific circuit converting compressed command codes into the original command codes thereof, and to re-design the additional specific circuit when the program and/or the command set have/has been changed.

Useless man-day and useless risk accompanying the re-design of the specific circuit can be suppressed, and flexibility of the design of the data-processing device can be improved.

A fourth aspect of the present invention provides a data-processing device comprising: a control circuit; and a data path controlled by the control circuit, wherein the control circuit includes a wired logic circuit operable to function as at least a part of command codes included in an object program generated according to a software specification.

According to the structure, it is unnecessary to provide the data-processing device with an additional specific circuit, such as a conversion circuit converting compressed command codes into the original command codes thereof like the conventional art. It is also unnecessary to change the number of command execution pipeline stages of the data-processing device. Furthermore, it is also unnecessary to provide a specific ROM especially designed for bit size and/or WORD size, because either a ROM or a RAM need not be used as a memory for storing command codes.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a designing procedure diagram of a data-processing device in an embodiment 1 of the present invention;

FIG. 2 (a) is an illustration showing an example of an object program in the embodiment 1 of the present invention;

FIG. 2 (b) is an illustration showing a first example of a second hardware description in the embodiment 1 of the present invention;

FIG. 3 is a flow chart of a converter in the embodiment 1 (a first example) of the present invention;

FIG. 4 is an illustration showing a second example of a second hardware description in the embodiment 1 of the present invention;

FIG. 5 is a flow chart of a converter in the embodiment 1 (the second example) of the present invention;

FIG. 6 is a block diagram of a data-processing device in an embodiment 2 of the present invention; and

FIG. 7 is a block diagram of a conventional data-processing device.

### DETAILED DESCRIPTION OF THE PREFERRED EMBODIMENTS

Embodiments of the present invention will now be described with reference to the accompanying drawings.

### Embodiment 1

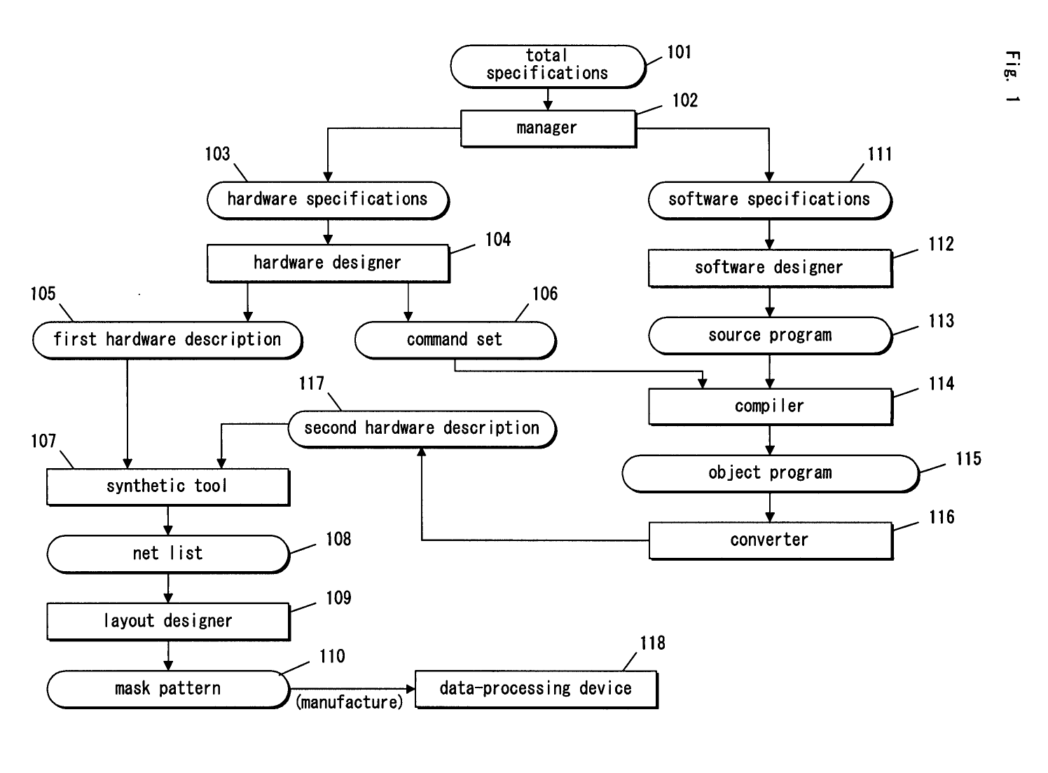

FIG. 1 is a designing procedure diagram of a data-processing device in an embodiment 1 of the present invention. When total specifications 101 have been determined, a manager 102 divides the total specifications 101 into hardware specifications 103 for hardware implementation and software specifications 111 for software implementation.

A hardware designer 104 considers the hardware specifications 103 to determine control structure, a kind of computing unit, the number of registers, the capacity of a storage, and so on. The hardware designer 104 designs hardware architecture and a command set 106 whose elements are various command codes for hardware elements. To be more specific, the hardware designer 104 describes a first hardware description 105 and a command set 106 in a hardware description language (HDL).

In the first hardware description 105, definitions and behaviors of the hardware elements (a computing unit, registers, an internal bus, and so on.) are defined. The command set 106 for the hardware elements is outputted to a compiler 114, because the command set 106 will be also used in a software design as described below.

On the other hand, a software designer 112, referring to the software specifications 111, describes a source program 113 that fulfills the software specifications 111 in a programming language (e. g., the C language and so on.). To be more specific, the software designer 112 determines procedures defining how basic processes utilizing the hardware should be combined, and describes a source program 113 for realizing the determined procedures.

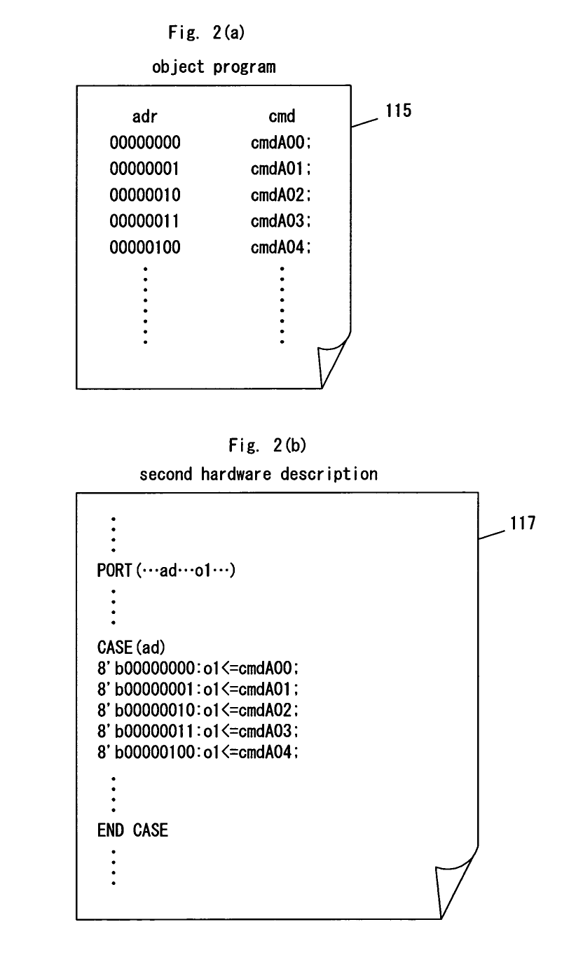

The compiler 114, referring to the command set 106 generated in the hardware design, compiles the source program to generate an object program 115 in a format which the hardware can execute. In addition, in this example, the compiler 114, which has been designed based on the command set 106 and information of the hardware, automatically converts the source program 113 into the object program 115. However, the source program 113 may be manually converted. Next, a converter 116 converts the object program 115 into a second hardware description 117. Referring to FIGS. 2 to 5, a first example and a second example of the converter will now be explained.

### First Example

According to the first example, when there is an object program 115 of FIG. 2 (a), as shown in FIG. 2 (b), a CASE statement is created in a second hardware description 117. In this CASE statement, the condition of the CASE statement is defined utilizing a command address of a storage in the object program 115, and a result of the command code corresponding to the command address is outputted from the CASE statement when the condition is fulfilled.

In other words, the converter 116 converts enumeration of the sets of the command address and the command code in the object program 115 into the second hardware description 117, which includes a selector scheme utilizing the CASE statement.

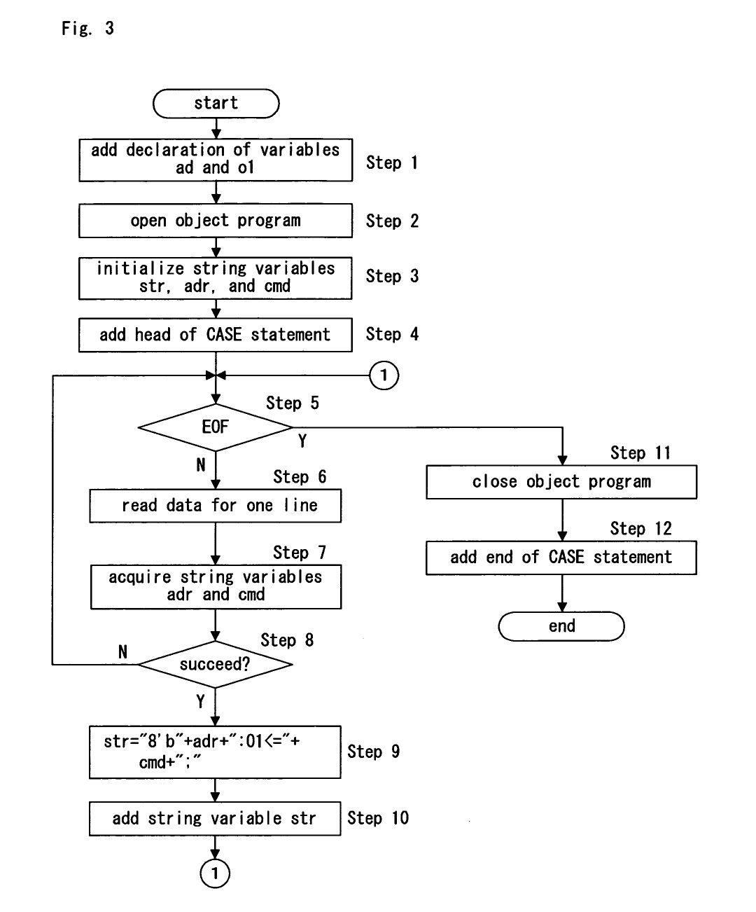

Next, referring to FIGS. 2 and 3, processes of the converter 116 in the first example will now be explained in detail.

First, at Step 1 of FIG. 3, the converter 116 adds the declaration of “PORT( . . . ad . . . ol . . . )” concerning variables ad and ol to the second hardware description 117. Here, the variable ad stores a command address in the object program 115, and the variable ol shows a content to be outputted.

At Step 2, the converter 116 opens the object program 115, and at Step 3, the converter 116 initializes string variables str, adr, and cmd. Here, the string variable str stores a statement to be added to the CASE statement, the string variable adr stores a command address of the object program 115, and the string variable cmd stores a command code corresponding to the command address.

At Step 4, the converter 116 adds head of the CASE statement of “CASE(ad)” at a position where description of the CASE statement should start. This head of the CASE statement indicates that processes should branch according to the value of the string variable ad between a plurality of statements that start at the head of the CASE statement, and that end at the tail of “ENDCASE” of the same.

Next, at Step 5, the converter 116 checks whether the file pointer of the object program 115 has not reached the end of the object program 115.

If reached, at Step 11, the converter 116 closes the object program 115, adds the end statement of “ENDCASE” to the second hardware description 117, and ends processing. If not reached, at Step 6, the converter 116 reads data for one line from the object program 115, and forwards the file pointer by the length of the data for one line.

At Step 7, the converter 116 tries to acquire, from the read data for one line, a command address to be stored in the string variable adr, and a command code to be stored in the string variable cmd.

If successfully, at Step 8, the converter 116 stores these values in the string variables adr and cmd, respectively, and processes move to Step 9. If unsuccessfully, the converter 116 moves processes to Step 5.

At Step 9, the converter 116 stores the character string of “8′b”+adr+“:ol<=”+cmd+“;” in the string variable str, and at Step 10, the converter 116 adds the value of the string variable str to the second hardware description 117. Thereby, one statement (e. g., “8′b00000000:ol<=cmdA00;”) in the CASE statement has been added. Here, the operator of “+” means the addition of character strings.

The converter 116 repeats processes of Steps 5 to 10 with respect to all the sets of the command address and the command code of the object program 115. Consequently, the CASE statement shown in FIG. 2 (b) has been added to the second hardware description 117.

As shown in FIG. 1, the second hardware description 117 generated by the converter 116 is inputted into a synthetic tool 107 as well as the first hardware description 105, and is logically synthesized to components of the data-processing device 118.

### Second Example

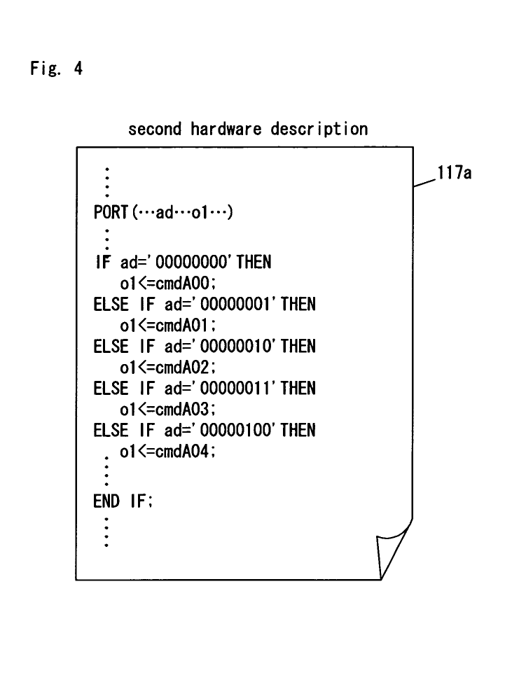

In the second example, when there is the object program 115 of FIG. 2 (a), as shown in FIG. 4, enumeration of IF statements is created in a second hardware description 117a. Hereafter, difference from the first example will now be explained.

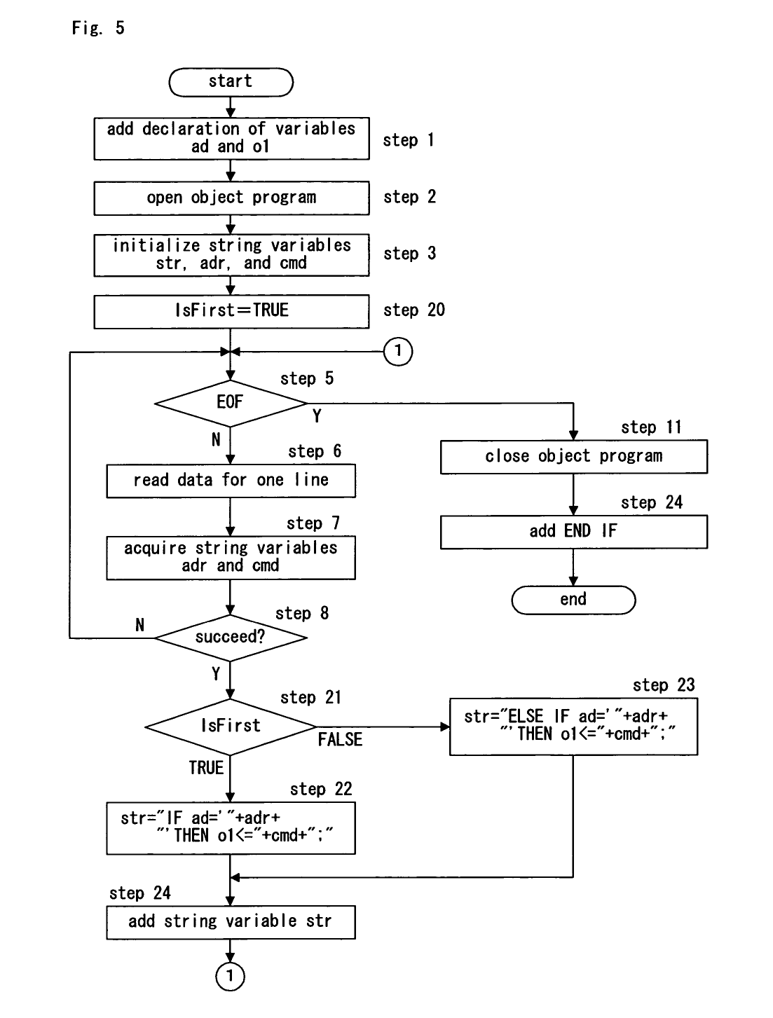

FIG. 5 corresponds to FIG. 3 of the first example. Steps 1 to 3 of FIG. 5 are the same as those of FIG. 3.

At Step 20, the converter 116 initializes a value of a BOOL type variable IsFirst to the value of “TRUE”. The variable IsFirst indicates whether a current position exists at the head position of the enumeration of the IF statements.

When the variable IsFirst indicates “TRUE”, the head of the IF statements should be “IF”, and when the variable IsFirst indicates “FALSE”, the head of the IF statements should be “ELSEIF”.

Steps 5 to 8 of FIG. 5 are the same as those of FIG. 3. When a file pointer to the object program 117 has reached the end of the object program 115, the converter 116 closes the object program 117 at Step 11, and then the end statement of “ENDIF” is added to the second hardware description 117a at Step 24 differing from the first example.

At Step 8, when the converter 116 succeeds to acquire the string variables adr and cmd, and then at Step 21, the converter 116 checks the value of the variable IsFirst.

When the variable IsFirst indicates “TRUE”, at Step 22, the converter 116 stores the character string of “IF ad=“‘+adr+’” THEN ol<=”+cmd+“;” in the string variable adr. When the variable IsFirst indicates “FALSE”, at Step 23, the converter 116 stores the character string of “ELSE IF ad=“‘+adr+’” THEN ol<=”+cmd+“;” in the string variable adr.

At Step 24, the converter 116 adds the string variable str stored at Step 22 or Step 23 to the second hardware description 117a. Thereby, one statement (e. g., “IF ad=‘00000000’ THEN ol<=cmdA00;”) of the enumeration of IF statements has been added.

The converter 116 repeats processes of Steps 5 to 24 concerning all the sets of the command address and the command code of the object program 115. Consequently, the enumeration of the IF statements shown in FIG. 4 has been added to the second hardware description 117a.

With respect to the first example and the second example, utilizing a programming language, such as the PERL, enumeration of command codes may be automatically converted into the hardware description including a CASE statement.

The first example shows a case of the CASE statement, and the second example shows a case of the enumeration of the IF statements. However, the other arbitrary kinds of descriptions may be used as long as the conditional branch can be performed correctly.

Next, referring to FIG. 1, design procedures after the first and second hardware descriptions 105 and 117 have been completed will now be explained. The synthetic tool 107 equally deals with the first and second hardware descriptions 105 and 117, carries out logic synthesis of the descriptions 105 and 117, and generates a net list 108.

Next, a layout designer 109 makes a mask pattern 110 based on the net list 108, after performing timing adjustment and so on. Thereby, the design of the data-processing device 118 has been completed. Afterwards, the substance of the data-processing device 118 will be manufactured based on the mask pattern 110.

According to the conventional technique, the object program 115, as it is, is stored in a memory (a ROM and so on.) in the data-processing device 118.

According to this embodiment, differing from the conventional art, the converter 117 converts the object program 115 into the second hardware description 117, and logic synthesis is performed based on both the first and second hardware descriptions 105 and 106.

This embodiment earns the following effects.

(Effect 1) The redundancy of the program can be removed and the hardware cost can be reduced.

(Effect 2) It is unnecessary to provide the data-processing device 118 with a specific circuit, such as a code conversion unit, depending on the program and command set for converting compressed command codes into original command codes like the conventional art.

Accordingly, even if the program and/or the command set have/has been changed, the man-day and risk for which re-design the specific circuit and so on can be suppressed.

### Embodiment 2

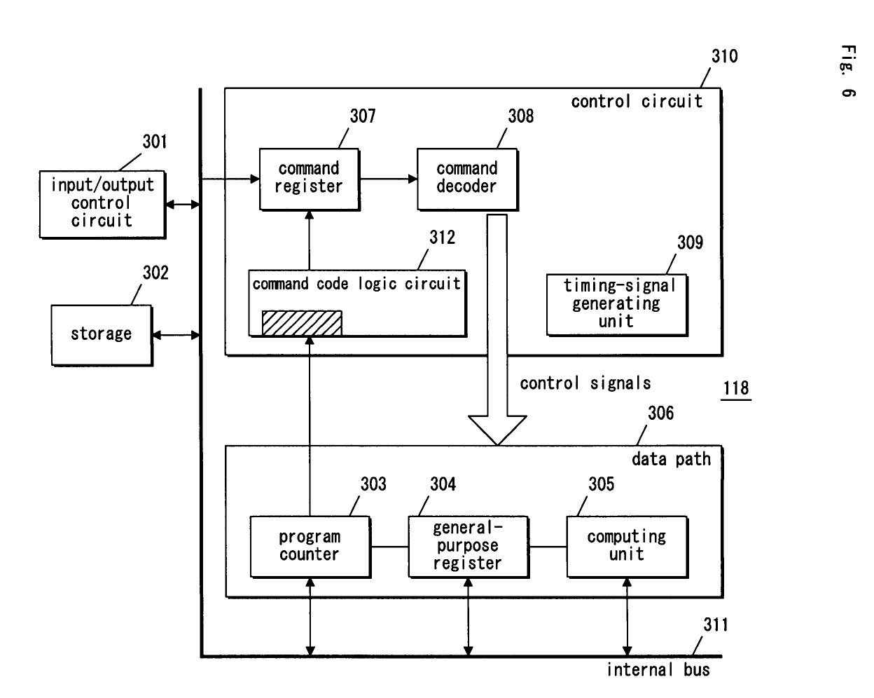

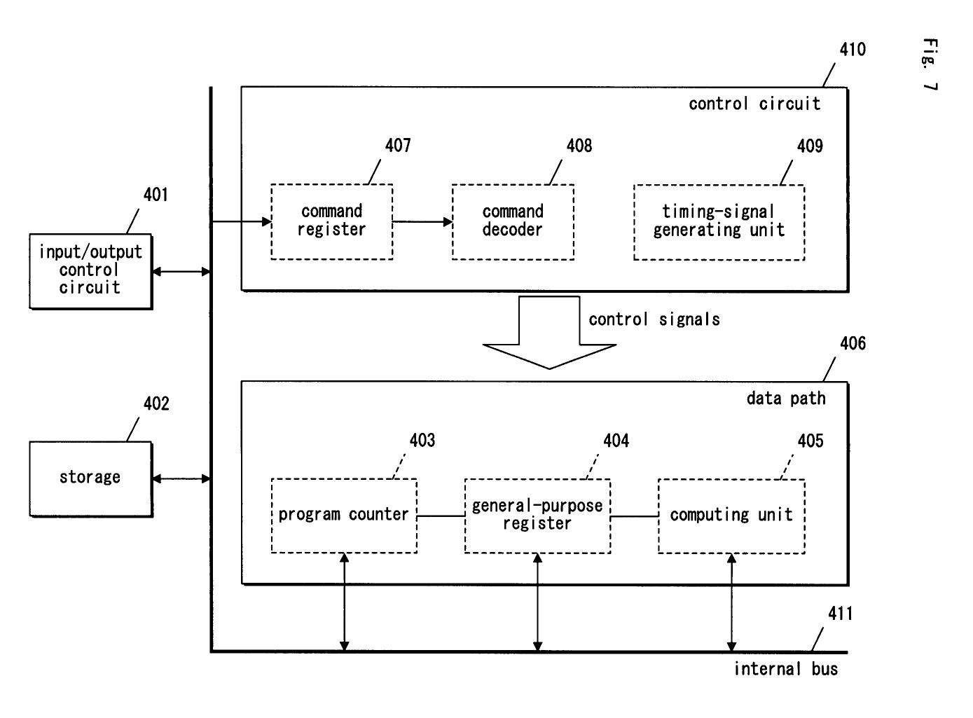

FIG. 6 is a block diagram of a data-processing device 118 in an embodiment 2 of the present invention. This data-processing device 118 is obtained according to the result of the design procedure of the embodiment 1.

The data-processing device 118 of FIG. 6 comprises the following elements. An input/output control circuit 301 controls input/output of data with the exterior. A storage 302, which is composed of a ROM and/or a RAM, stores data, such as data of a target of computing, and a result of the computing. A data path 306 computes and transmits the data.

A control circuit 310 decodes command codes and outputs control signals to the data path 306. An internal bus 311 connects the input/output control circuit 301, the storage 302, the data path 306, and the control circuit 310, and enables transmission and reception of the data.

The data path 306 comprises the following elements. A program counter 303 is a kind of register and stores an address of a command code stored in a command code logic circuit 312 to be operated next. A general-purpose register 304 stores various kinds of data. A computing unit 305 performs necessary arithmetic calculation, logical calculation, and so on to the data stored in the general-purpose register 204.

A control circuit 310 comprises the following elements. The command code logic circuit 312 is implemented not by a memory storing the object program but by a hardware logic circuit logically composed derived from the object program. The command code logic circuit 312 is a wired logic circuit constituted based on the net list 108.

Since the net list 108 has been generated logically synthesizing the first and second hardware descriptions 105 and 117, a part of the command code logic circuit 312 (See, the slash section of FIG. 6) corresponds to the second hardware description 117 generated converting the set of the command addresses and the command codes of the object program 115.

A command decoder 308 decodes the command code stored in the command register 307, and outputs control signals to the data path 306. A timing-signal generating unit 309 generates synchronous clock signals concerning whole operation of the data-processing device 118.

Next, operation of the data-processing device 118 of FIG. 6 will now be explained. Assume that the data-processing device 118 carries out parallel processes under pipeline control composed of the following stages.

Stage 1: The head address of a program is read from a predetermined address of the command code logic circuit 312, and is set to the program counter 303.

Stage 2: A command code stored in the address specified by the program counter 303 is read from the command code logic circuit 312, and is set to the command register 307. Here, the value of the program counter 303 is incrementally added as often as the command code is read.

Stage 3: The command decoder 308 decodes the command code stored in the command register 307, and outputs control signals to the data path 306.

Stage 4: The computing unit 305 executes a command according to the control signals.

When the command code is a code for a branch instruction, a command code address that the branch instruction indicates is set to the program counter 303, and the parallel processes under the pipeline control are initialized. Then, the processing processes of Stages 2-4 are performed in a pipeline manner for every command code.

This embodiment earns the following effects.

(Effect 1) At least a part of the executable object program composed of an array of command codes is provided not in a memory but in the command code logic circuit 312. Accordingly, redundancy in the direction of the address and hardware cost can be reduced comparing with a case where a memory area for storing command codes is provided in the storage 302.

(Effect 2) It is unnecessary to provide a specific circuit converting compressed command codes into original command codes like the conventional art. The number of command execution pipeline stages of the data-processing device is not affected.

(Effect 3) Since either a ROM or a RAM need not be used as a memory storing command codes, it is unnecessary to provide a specific ROM designed considering halfway bit or WORD size.

(Effect 4) The redundant portion in the array of command codes can be reduced regardless of the property of the program, the command set, the command code length, and the storage (ROM and RAM). The hardware cost can be reduced.

Having described preferred embodiments of the invention with reference to the accompanying drawings, it is to be understood that the invention is not limited to those precise embodiments, and that various changes and modifications may be effected therein by one skilled in the art without departing from the scope of the invention as defined in the appended claims.

What is claimed is:

1. A method for manufacturing a data-processing device, the method comprising:
generating, based on a software specification, an object program including a plurality of command codes; and
constituting a wired logic circuit that functions as at least a part of the plurality of command codes.

2. A method for designing a data-processing device, the method comprising:
generating, based on a software specification, an object program including a set of a command address and a command code;
converting the set of the command address and the command code into a hardware description; and
generating a net list according to the hardware description.

3. The method as claimed in claim 2, wherein the hardware description includes a description conditionally describing a command code to be executed in accordance with the command address.

4. A method for designing a data-processing device, the method comprising:
generating, based on a hardware specification, a first hardware description and a command set;
generating a source program based on a software specification and the command set;
converting the source program into an object program including a set of a command address and a command code;
converting the set of the command address and the command code into a second hardware description; and
logically synthesizing the first and second hardware descriptions, thereby generating a net list.

5. The method as claimed in claim 4, further comprising dividing a total specification of the data-processing device into the hardware specification and the software specification.

6. A data-processing device comprising:
a control circuit; and
a data path controlled by said control circuit,
wherein said control circuit includes a wired logic circuit operable to function as at least a part of command codes included in an object program generated according to a software specification.

7. The data-processing device as claimed in claim 6, wherein an object program is generated based on the software specification,
wherein a set of a command address and a command code included in the object program is converted into a hardware description,
wherein a net list is generated according to the hardware description, and
wherein said wired logic circuit is manufactured according to the net list.

8. The data-processing device as claimed in claim 7, wherein said data path includes a program counter,
wherein said control circuit decodes a command code indicated by said program counter, thereby outputting a corresponding control signal to said data path, and
wherein said data path, in accordance with the corresponding control signal, executes arithmetic calculation, logical calculation, and data transmission.
